(19) United States
(12) Patent Application Publication
(10) Pub. No.: US 2006/0277228 A1
(43) Pub. Date: Dec. 7, 2006

(54) Method and apparatus for manipulating remote database through remote access

(75) Inventor: Kenji Kusunose, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/237,188

(22) Filed: Sep. 28, 2005

(30) Foreign Application Priority Data
Jun. 3, 2005 (JP) 2005-163375

(51) Int. Cl. G06F 17/30

(52) U.S. Cl. 707/202

(57) ABSTRACT

A computer program that can manipulate a remote database at higher speeds even in the case where different kinds of processing requests are produced. A record fetching unit produces a record retrieval request, and a message sending unit sends it to a remote database. Records retrieved from the remote database are then stored in a record storage unit. With subsequent data modification commands, a data modification unit modifies database records stored in the record storage unit, during which a modification logging unit creates a modification log in a modification log storage unit to record each change made to the records. If such a modification log is present in the modification log storage unit when a new record retrieval request arises, the message sending unit creates update requests from the modification log entries and sends them, together with the new record retrieval request, to the remote database in a single message.

### CROSS-REFERENCE TO RELATED APPLICATIONS

This application is based upon and claims the benefits of priority from the prior Japanese Patent Application No. 2005-163375 filed on Jun. 3, 2005, the entire contents of which are incorporated herein by reference.

### BACKGROUND OF THE INVENTION

1. Field of the Invention

The present invention relates to a method and apparatus for manipulating a database through remote access, and more particularly to a remote database manipulation method and apparatus that perform remote access with fewer messages. The present invention also relates to a computer-readable medium storing a program for realizing the same on a computer platform.

2. Description of the Related Art

Some server systems providing users with various services have a multilayer structure of data processing functions, with separate server computers assigned for different tasks. For example, one such system employs an application server to accept user requests and a database server to manage data objects used in the services that the application server offers. These two servers cooperate closely to serve the users. Specifically, the application server uses remote access facilities to manipulate data records in the database server according to user requests.

With the conventional database manipulation method using remote access, record retrieval requests (e.g., search database) are processed independently of record modification requests (e.g., change data, delete data); i.e., they are executed as separate commands. Suppose, for example, that a record search command is issued in the application server. In this case, the application server makes access to the remote database server in an attempt to retrieve data records from there. The retrieved records are delivered back to the application server. If some process in the application server issues a data modification command for those records, then the application server transmits a modification request message to the database server, thus modifying specified database records. In this way, the application server interacts with the database server each time a new processing request arises.

The speed of database transactions is a key factor in enhancing the system performance and efficiency. For this reason, various methods have been proposed for more efficient database processing. One example is a method known as the “stored procedure.” A stored procedure is a set of database manipulation commands that has been compiled and stored on the database server. More specifically, each procedure of database processing is described as a series of Data Manipulation Language (DML) commands, such as Structured Query Language (SQL) commands used in relational databases. Instead of sending DML commands to the database server each time an application needs to manipulate database records, a DML stored procedure is defined and stored on the database server. The application commands the database server to call the stored procedure when it is needed. This technique reduces the necessity of sending processing requests from client applications to the database server, thus improving the efficiency of data access.

To take full advantage of stored procedures, application designers have to reduce the number of procedure calls (i.e., to combine database access operations in an application) as much as possible when they code business logic and data access logic of applications. This in turn means that the stored procedure method is not flexible enough to handle various data access needs that different applications would have. In other words, high-speed database access can only be achieved at the sacrifice of flexibility of application design and programming.

To address the above shortcomings, some researchers have proposed a technique to reduce the number of messages to be transmitted. See, for example, Japanese Patent Application Publication No. 2004-86299. According to the proposed method, in the case where an application repeats modifying a retrieved database record, the application sends only the final result of that record to the database server, rather than sending all individual modifications made to it. If there are two or more such data records, then the application combines similar processing requests (e.g., data update requests for multiple data records) into a single message, thereby reducing the frequency of message transmission.

The proposed technique described above, however, is merely to combine a plurality of similar processing requests into a single message. For example, a plurality of search requests can be delivered together in a message, or a plurality of update requests can also be carried together. The problem here is that it is unable to transmit different types of processing requests in a single message. While the number of messages can be reduced when similar processing requests arise consecutively, dissimilar processing requests still require separate messages to deliver them. Even when, for example, a data update request is immediately followed by a search request, these requests must be transmitted in two separate messages. It is therefore desirable to develop a technique to speed up database access even in a situation where different types of processing requests are transmitted.

### SUMMARY OF THE INVENTION

In view of the foregoing, it is an object of the present invention to provide a computer program, method, and apparatus that can manipulate a remote database at a higher speed even in the case where different kinds of processing requests are produced.

To accomplish the above object, the present invention provides a computer-readable medium storing a computer program for manipulating a remote database through remote access. This computer program causes a computer to function as a system comprising the following elements: (a) a record fetching unit that produces a record retrieval request to the remote database in response to a given record retrieval command; (b) a record storage unit that stores records retrieved from the remote database as a result of the record retrieval request; (c) a data modification unit that modifies data elements of the records stored in the record storage unit according to given data modification commands; (d) a modification logging unit that creates a modification log by keeping track of the modifications made by the data modification unit; (e) a modification log storage unit that stores the modification log created by the modification logging unit; and (f) a message sending unit that produces update requests from the modification log when the record fetching unit has produced a new record retrieval request and then sends the remote database a message containing the new record retrieval request and the update requests to update the remote database with the modifications made by the data modification unit.

To accomplish the above object, the present invention provides a method for manipulating a remote database through remote access. This method comprises the following steps: (a) sending a record retrieval request to the remote database in response to a given record retrieval command; (b) storing records retrieved from the remote database as a result of the record retrieval request; (c) modifying data elements of the stored records according to given data modification commands; (d) creating a modification log by keeping track of the modifications made to the stored records; (e) producing update requests from the modification log when a new record retrieval request is produced; and (f) sending the remote database a message containing the new record retrieval request and the update requests to update the remote database with the modifications that have been made to the stored records.

Further, to accomplish the above object, the present invention provides an apparatus for manipulating a remote database through remote access. This apparatus has the following elements: (a) a record fetching unit that produces a record retrieval request to the remote database in response to a given record retrieval command; (b) a record storage unit that stores records retrieved from the remote database as a result of the record retrieval request; (c) a data modification unit that modifies data elements of the records stored in the record storage unit according to given data modification commands; (d) a modification logging unit that creates a modification log by keeping track of the modifications made by the data modification unit; (e) a modification log storage unit that stores the modification log created by the modification logging unit; and (f) a message sending unit that produces update requests from the modification log when the record fetching unit has produced a new record retrieval request and then sends the remote database a message containing the new record retrieval request and the update requests to update the remote database with the modifications made by the data modification unit.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 provides an overview of an embodiment of the present invention.

FIG. 2 is a block diagram of a system according to the present embodiment.

FIG. 3 illustrates a computer hardware platform for the present embodiment.

FIG. 4 is a block diagram showing the functions of an application server and a database server.

FIG. 5 is shows an example of remote database access.

FIG. 6 shows how an application server obtains and modifies a database record.

FIG. 7 shows the format of messages.

FIG. 8 shows how a database server operates.

FIG. 9 shows a command sequence submitted in a single transaction.

FIG. 10 is a flowchart showing how a remote database access processor operates.

FIG. 11 is a flowchart showing how a database access processor operates.

### DESCRIPTION OF THE PREFERRED EMBODIMENTS

Preferred embodiments of the present invention will be described below with reference to the accompanying drawings, wherein like reference numerals refer to like elements throughout.

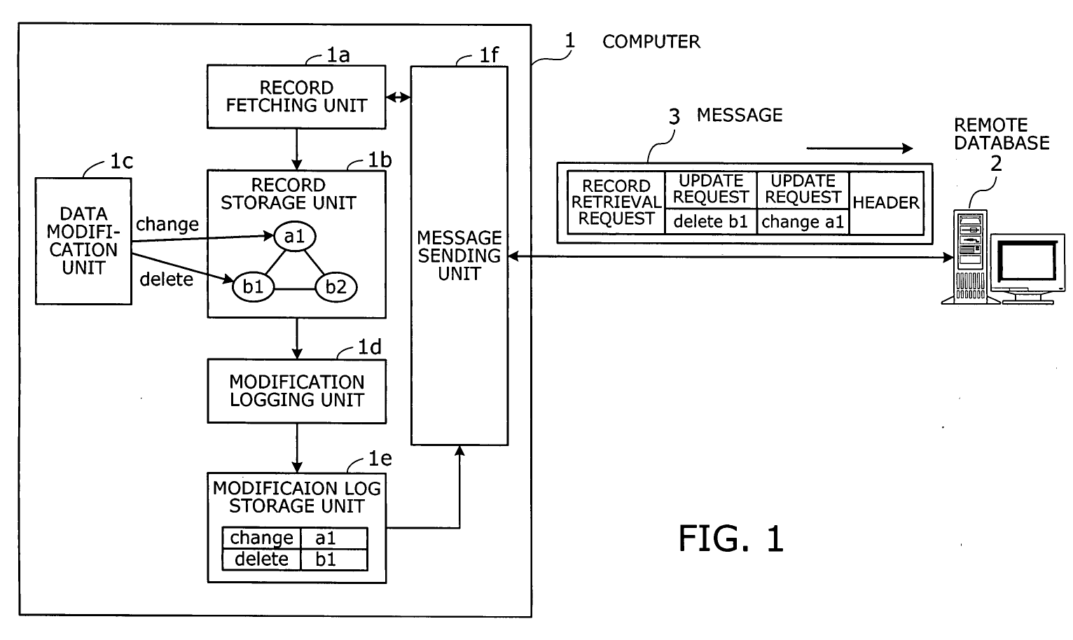

FIG. 1 provides an overview of an embodiment of the present invention. The illustrated computer 1 has, among others, a record fetching unit 1a, a record storage unit 1b, a data modification unit 1c, a modification logging unit 1d, a modification log storage unit 1e, and a message sending unit 1f.

The record fetching unit 1a produces a record retrieval request in response to a given record retrieval command so as to retrieve records from a remote database 2. The record storage unit 1b stores retrieved records that the record fetching unit 1a has received from the remote database 2 in response to the record retrieval request.

The data modification unit 1c modifies data elements of the records in the record storage unit 1b according to given data modification commands, which include, for example, changing and deleting existing data and adding new data. The modification logging unit 1d keeps track of modifications made by the data modification unit 1c, thereby storing a modification log in the modification log storage unit 1e.

The message sending unit 1f determines whether any modification log is present in the modification log storage unit 1e at the time when the record fetching unit 1a produces a new record retrieval request. If no such modification log is found, the message sending unit 1f sends a message indicating the new record retrieval request addressed to the remote database 2. If, on the other hand, the modification log storage unit 1e has a modification log, the message sending unit 1f produces update requests so as to update the remote database 2 with every modification made to the records by the data modification unit 1c. The message sending unit 1f sends the remote database 2 a message 3 containing the new record retrieval request and update requests.

The above-described computer 1 operates as follows. In response to a given record retrieval command, the record-fetching unit 1a issues a record retrieval request in an attempt to retrieve records from the remote database 2. If the modification log storage unit 1e has no modification logs, the message sending unit 1f sends the remote database 2 a message containing a record retrieval request alone. As a result of the record retrieval request, the record fetching unit 1a receives records from the remote database 2 and stores them in the record storage unit 1b.

Subsequent data modification commands cause the data modification unit 1c to modify data elements of the database records stored in the record storage unit 1b, where the modification logging unit 1d records modifications made by the data modification unit 1c as a modification log in the modification log storage unit 1e. For one example, when a data element “a1” is changed, the modification logging unit 1d creates a new log entry in the modification log storage unit 1e. This new log entry indicates the operation “change” and data ID “a1.” For another example, when data “b1” is deleted, the modification logging unit 1d creates another log entry indicating the operation “delete” and data ID “b1.”

Since the modification log storage unit 1e has the above-described modification log at the time when a new record retrieval request is produced by the record fetching unit 1a, the message sending unit 1f creates update requests from the modification log entries and sends those update requests, together with that new record retrieval request, to the remote database 2 by combining them into a single message 3.

More specifically, in the case an update request is for a data change, the message sending unit 1f retrieves the latest data value from the record storage unit 1b and puts that value into the update request. For example, FIG. 1 shows a data element a1 with a value that has been changed by the data modification unit 1c. The message sending unit 1f therefore retrieves the current value of data element “a1” from the record storage unit 1b and creates an update request with the retrieved data value of “a1” and puts it into the message 3.

It should be noted that, according to the present embodiment, the message 3 contains two different kinds of processing requests. In this way, the computer 1 interacts with the remote database 2 more effectively, using a reduced number of messages. Unlike the stored procedures mentioned earlier, the present embodiment can flexibly deal with variations in application processes.

In processing the above-described message 3, the remote database 2 is required to give a higher priority to update requests than record retrieval requests. The present embodiment assumes that the remote database 2 is configured to serve such requests in a received message in the order of their appearance after the header information. The message sending unit 1f therefore assembles a message 3 by placing update requests after the header, and then record retrieval request.

It is also necessary to update the remote database 2 with all modifications made by the data modification unit 1c, in the order that they have been applied to the record storage unit 1b. The modification logging unit 1d is therefore designed to create a modification log in the modification log storage unit 1e, preserving the order of their execution. In the modification log storage unit 1e shown in FIG. 1, the topmost log entry represents the earliest modification to the record storage unit 1b. The subsequent modification event is logged in the second entry. Those modification log will be delivered later as part of a message 3 to the remote database 2. The message sending unit 1f places the modification log data in this message 3 according to the order of their entry to the modification log storage unit 1e. This makes it possible to update the remote database 2 with the same modifications as, and in the same order as, the data modification unit 1c has made to the record storage unit 1b.

It would not matter how the processing requests are arranged within a message 3 if some other method can be implemented in the remote database 2 to preserve the order of execution. One such method is to include a timestamp in each update request to indicate when that modification was made. In this case, the remote database 2 is designed to make update requests a higher priority than record retrieval requests, and to consult the timestamp when it determines which update request to serve first. Processing requests to the remote database 2 are therefore executed in an appropriate order.

The following sections will describe a specific embodiment of the present invention. In this embodiment, a message containing update requests (if any) is produced, not only when a new record retrieval request arises, but also when any other access to a remote database is to take place.

### Distributed Server System

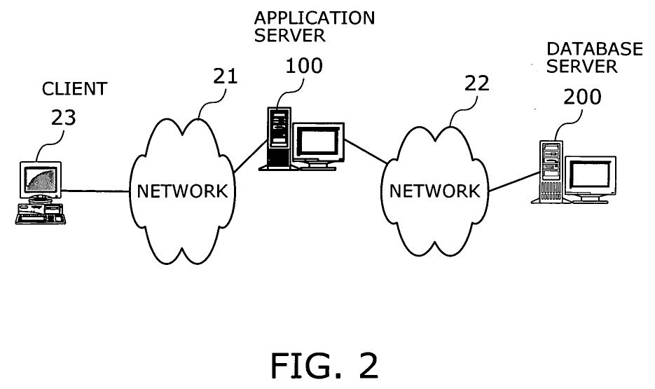

FIG. 2 is a block diagram of a distributed system according to the present embodiment. This embodiment involves an application server 100 and a database server 200. A user computer, or client, 23 is connected to the application server 100 via a network 21, where the network 21 is a wide area network like the Internet. The application server 100 has data processing functions implemented as application software. With those application-based processing functions (hereafter “applications”), the application server 100 provides the client 23 with various data processing services. The application server 100 is connected to the database server 200 via another network 22. The database server 200 manages its local database subsystems upon request from the application server 100.

Each request from the client 23 travels over the first network 21 and reaches the application server 100 as a processing request. Suppose, for example, that a web server application is running on the application server 100, so that a web browser on the client 23 can communicate with the web server application. Upon receipt of a console input given by the user, the client 23 sends a corresponding processing request to the web server application. The application server 100 invokes an appropriate task according to the processing request from the client 23, and if that task involves database access, the application server 100 interacts with the database server 200 over the second network 22 in order to manipulate the database. In the case there are two or more processing requests to be transmitted, the application server 100 puts them into a single message, thereby reducing message traffic between servers.

Computer Hardware Platform

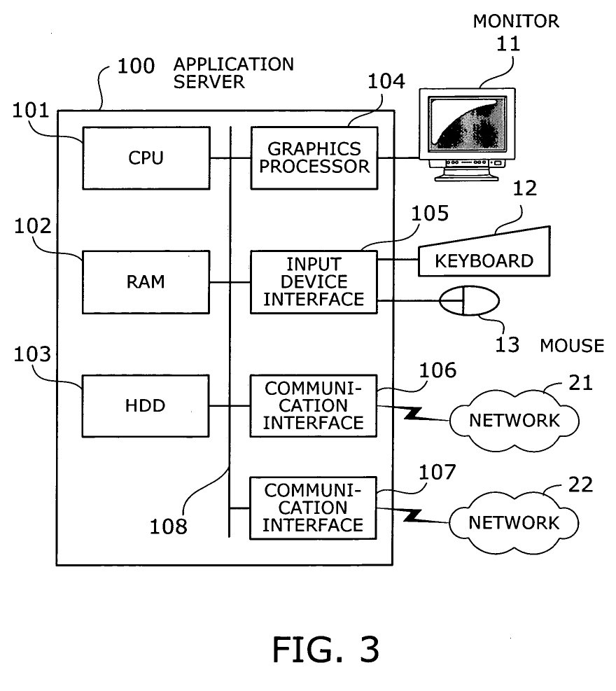

FIG. 3 illustrates a computer hardware platform for the present embodiment. The illustrated application server 100 has the following elements: a central processing unit (CPU) 101, a random access memory (RAM) 102, a hard disk drive (HDD) 103, a graphics processor 104, an input device interface 105, and two communication interfaces 106 and 107. The CPU 101 controls the entire system of the application server 100, interacting with other elements via a bus 108.

The RAM 102 serves as temporary storage for the whole or part of operating system (OS) programs and application programs that the CPU 101 executes, in addition to other various data objects manipulated at runtime. The HDD 103 stores program and data files of the operating system and various applications.

The graphics processor 104 produces video images in accordance with drawing commands from the CPU 101 and displays them on the screen of an external monitor 11 coupled thereto. The input device interface 105 is used to receive signals from external input devices, such as a keyboard 12 and a mouse 13. Those input signals are supplied to the CPU 101 via the bus 108.

The communication interface 106 is connected to a network 21, allowing the CPU 101 to exchange data with a client 23. The communication interface 107 is connected to another network 22, allowing the CPU 101 to exchange data with a database server 200.

The computer described above serves as a hardware platform for realizing the processing functions of the present embodiment. While FIG. 3 illustrates a platform for the application server 100, the same hardware structure can also be applied to the client 23 and database server 200.

### Application Server Structure

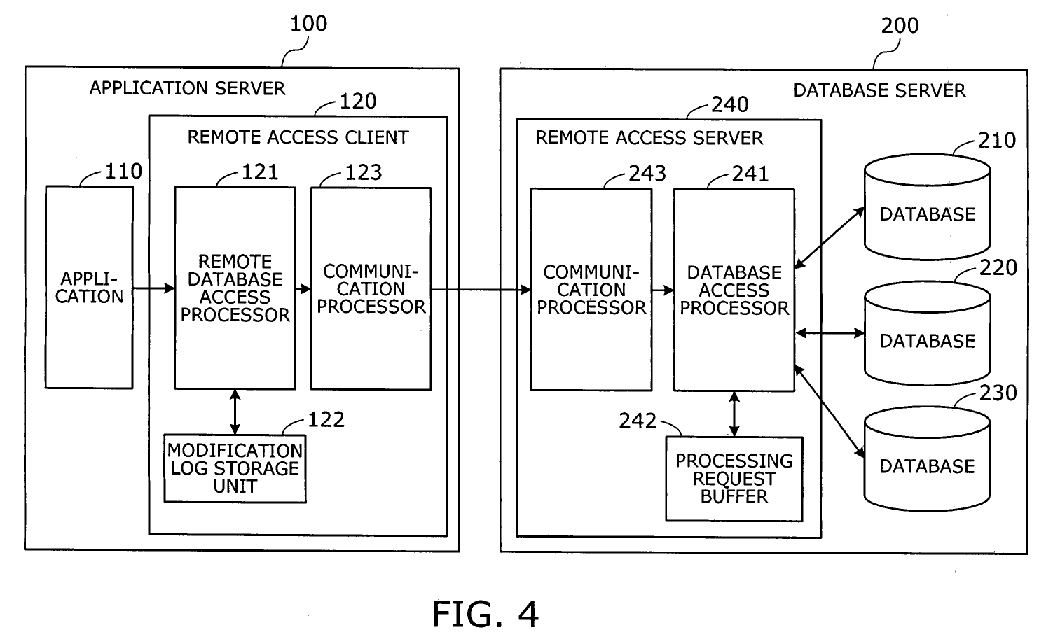

FIG. 4 is a block diagram showing the functions implemented in the application server 100 and database server 200. Specifically, the application server 100 has a remote access client 120 to receive and handle incoming processing requests from an application 110. The database server 200, on the other hand, has a remote access server 240 to make access to databases 210, 220, and 230 according to processing requests received from the application 110 via the remote access client 120.

The remote access client 120 is formed from a remote database access processor 121, a modification log storage unit 122, and a communication processor 123. The remote database access processor 121 have remote access to the databases 210, 220, and 230 in the database server 200, in response to database manipulation commands from the application 110. The database manipulation commands include: connect (open), disconnect (close), search, and update. If a command received from the application 110 requires access to the databases 210, 220, and 230, as in the case of a record search command, the remote database access processor 121 creates a message containing one or more processing requests to the databases 210, 220, and 230. If this is the case, the remote database access processor 121 consults the modification log storage unit 122 to determine whether there is a modification log for the existing database records. In the case that a modification log exists in the modification log storage unit 122, the remote database access processor 121 places the corresponding update requests (e.g., data change, delete) in the message to be sent. The resulting message is then sent out to the database server 200 through the remote database access processor 121.

The remote database access processor 121 also receives database records (each containing multiple pieces of information) that the database server 200 provides in response to a record-requesting message. The application 110 may subsequently issue some commands related to those local database records. The remote database access processor 121 thus modifies the records according to each such command, and it creates a log in the modification log storage unit 122 to register which database records are modified and how. This log data includes the identifier of each modified record.

The modification log storage unit 122 stores a time-sequential log of data modifications (e.g., change, delete, add) that the application 110 has made to the databases 210, 220, and 230. This modification log storage unit 122 may be implemented as part of memory space of the RAM 102 (FIG. 3).

The communication processor 123 delivers messages of the remote database access processor 121 to the database server 200. The communication processor 123 also receives database records from the database server 200 as a response to the messages. Those received records are passed to the remote database access processor 121.

The remote access server 240 in the database server 200 is formed from the following elements: a database access processor 241, a processing request buffer 242, and a communication processor 243. The database access processor 241 handles messages sent from the application server 100. That is, the database access processor 241 makes access to the databases 210, 220, and 230 to manipulate data elements in the records according to a processing request in each received message. In the case the received message contains two or more processing requests, the database access processor 241 saves them in a processing request buffer 242 without changing their original sequence, so that it can execute those requests in the same order as they are saved. The processing request buffer 242 keeps such processing requests in the order that they are received as part of messages from the application server 100.

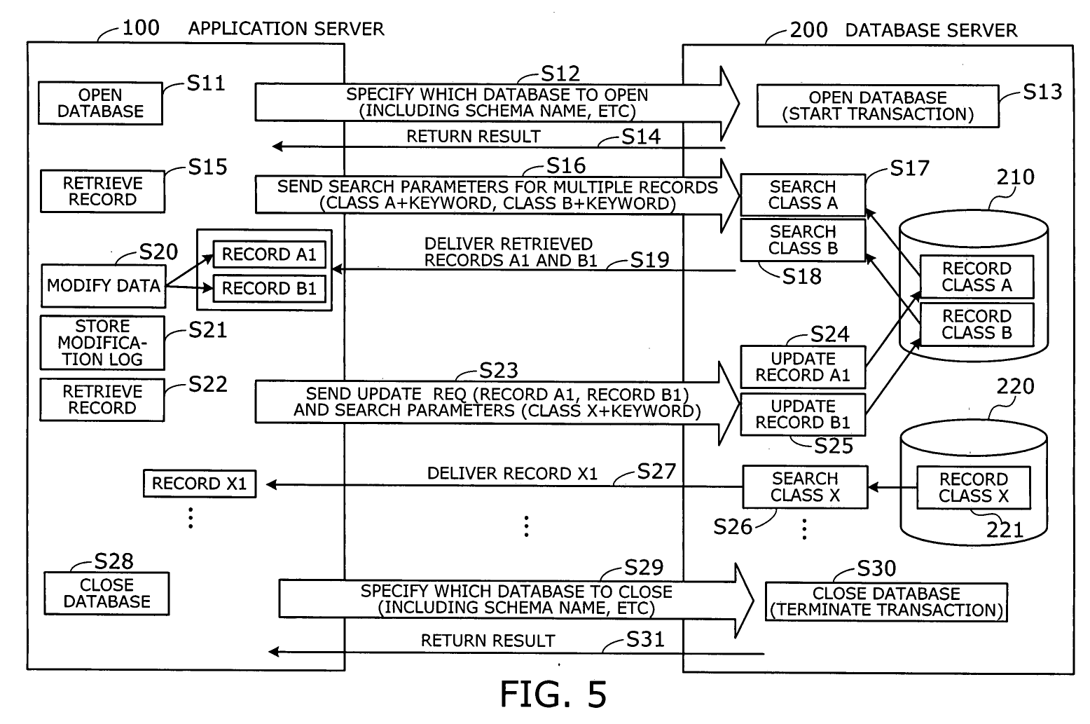

Referring to FIG. 5, the system of FIG. 4 permits the application server 100 to have remote database access as follows. In an attempt to manipulate databases 210, 220, and 230 in the database server 200, the application 110 issues a database open command to the remote access client 120. This command causes the remote database access processor 121 in the remote access client 120 to create a message carrying an open request (step S11). Specifically, the message contains information specifying which database to open (e.g., schema name). The created message is transmitted to the database server 200 through the communication processor 123 (step S12).

The message reaches the database server 200 and is received by the database access processor 241 in the remote access server 240 via the communication processor 243 (step S13), which marks the beginning of a transaction. Suppose, for example, that two databases 210 and 220 are opened by the request message. Upon completion of this database opening operation, the remote access server 240 sends the result to the requesting application server 100 (step S14).

The remote database access processor 121 performs record retrieval in response to a record search command from the application 110 (step S15). More specifically, the remote database access processor 121 creates a query message containing two or more sets of search parameters for retrieval of records. The search parameters in the present example are: (1) record class A+search keyword, and (2) record class B+search keyword. Specifying record classes A and B means specifying which database to search. For example, “Product” and “Inventory” are such record classes. The produced message is delivered by the communication processor 123 to the database server 200 (step S16).

The message reaches the database server 200 and is received by the database access processor 241 in the remote access server 240 via the communication processor 243. The database access processor 241 thus makes access to the database 210 to search the records of class A (step S17), as well as to search the records of class B (step S18). This search yields a set of records that fall in the specified record classes and also match with the specified keywords.

The database access processor 241 delivers the retrieved records A1 and B1 back to the application server 100 (step S19). These records are then passed to the requesting application 110, besides being stored in the remote database access processor 121 of the application server 100. Subsequent data manipulation commands from the application 110 cause the remote database access processor 121 to modify the stored records (step S20) It is assumed in the present example that both records A1 and B1 are modified.

The remote database access processor 121 creates a modification log in the modification log storage unit 122 to indicate which data records are modified and how (step S21). In the case the same data element has been modified two or more times, the remote database access processor 121 compresses the corresponding modification log entries, rather than logging all individual modifications. Specifically, the remote database access processor 121 manages the modification log such that only the latest state of that data element will be maintained in it (i.e., old log entries are discarded).

Suppose now that the application 110 issues a record search command, causing the remote database access processor 121 to create a message requesting a search for database entries of record class X (step S22). When composing this message, the remote database access processor 121 consults the modification log storage unit 122 to check the presence of a modification log. In the present context, the modification log storage unit 122 contains a modification log indicating past modifications made to the records A1 and B1. Accordingly the remote database access processor 121 adds update requests for those records A1 and B1 to the search command message to be transmitted. The communication processor 123 now transmits to the database server 200 the message containing one search command and two update requests (step S23).

The message reaches the database server 200 and is received by the database access processor 241 in the remote access server 240 via the communication processor 243. The database access processor 241 first updates record A1 according to its corresponding update request (step S24), and then updates record B1 according to its corresponding update request (step S25). Lastly, the database access processor 241 invokes a retrieval of record class X from the database 220 (step S26). The database access processor 241 then delivers the retrieved record X1 to the requesting application server 100 (step S27). This record X1 is then passed to the requesting application 110, besides being stored in the remote database access processor 121 of the application server 100.

The application 110 may produce further requests for manipulation of remote databases. The application server 100 and database server 200 will handle such requests in the same way as described above. Finally, the application 110 issues a database closing command, which causes the remote database access processor 121 to create a message containing a close request (step S28). Specifically, this message contains information specifying which database to close (e.g., schema name). The created message is transmitted to the database server 200 through the communication processor 123 (step S29). At the database server 200, the database access processor 241 closes the specified databases (step S30), thus terminating the transaction. Finally the database access processor 241 notifies the application server 100 of the processing result (step S31). In this way, past modifications made to database records are applied all at once later when a new record search command is issued (or when the database are closed).

### Modification and Update

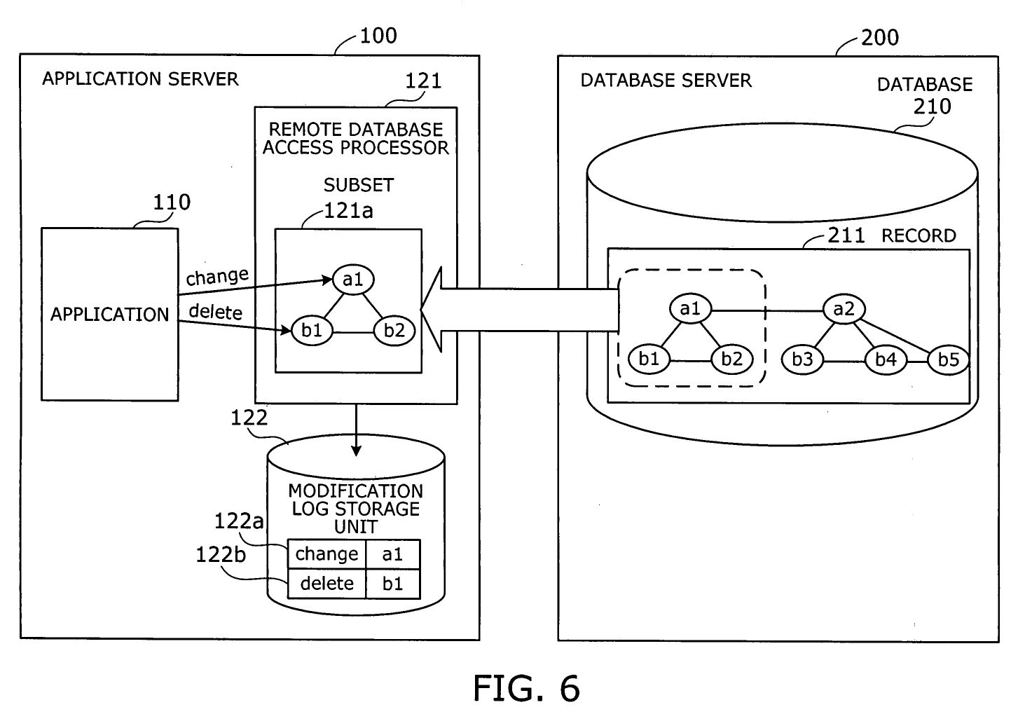

Referring now to FIGS. 6 to 8, this section gives a specific example to explain how a database record is modified at an application server and how those modifications are reflected in the original database. First, FIG. 6 shows how the application server 100 obtains and modifies a database record. As can be seen from FIG. 6, the application server 100 receives a set of data records of the database 210 as a result of a search request that it sent to the database server 200. More specifically, the database 210 in the present example is a network database, from which a part of a record 211 has been extracted and supplied to the application server 100. This partial copy of the database record is referred to as a subset 121a.

The subset 121a is kept in the remote database access processor 121. With a database manipulation command issued from the application 110, the remote database access processor 121 modifies the subset 121a. FIG. 6 illustrates a change command to one data record a1 and a delete command to another data record b1.

Each time the subset 121a is modified, the remote database access processor 121 creates a modification log entry to record each executed manipulation command. In the case of FIG. 6, new modification log entries 122a and 122b are entered to the modification log storage unit 122 as the data manipulations are performed.

Suppose that the application 110 subsequently issues a new record search command to fetch another piece of data from the remote database 210. In response this command, the remote database access processor 121 creates a message containing a search request produced from the record search command, together with update requests produced from the modification log entries 122a and 122b.

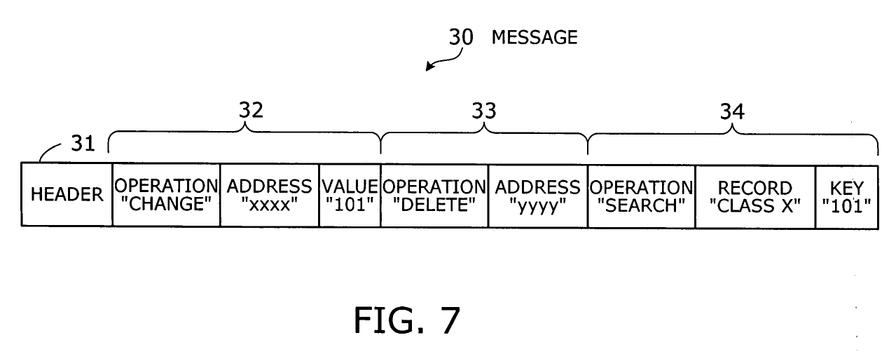

FIG. 7 shows the format of this message. The message 30 is composed of header information 31 and various processing requests including update requests produced from corresponding modification log entries stored in the modification log storage unit 122. The order of the original log entries is maintained in the message 30. The record search command from the application 110 is also included in the message 30 as its last processing request.

In the example of FIG. 7, the header information 31 is followed by a processing request 32 for a data change operation corresponding to the first modification log entry 122a. This processing request 32 is followed by another processing request 33, which specifies a data delete operation corresponding to the second modification log entry 122b. The last part of the message 30 is yet another processing request 34 corresponding to a record search command from the application 110.

Each processing request 32 to 34 begins with an operation field. Database update operations include “change” and “delete.” The operation field in this case is followed by an address field specifying which data element is to be updated. The address of each data element has been supplied to the remote database access processor 121 as part of search results sent from the database server 200. The processing request 32 for a data change operation further specifies a new data value for the specified data element.

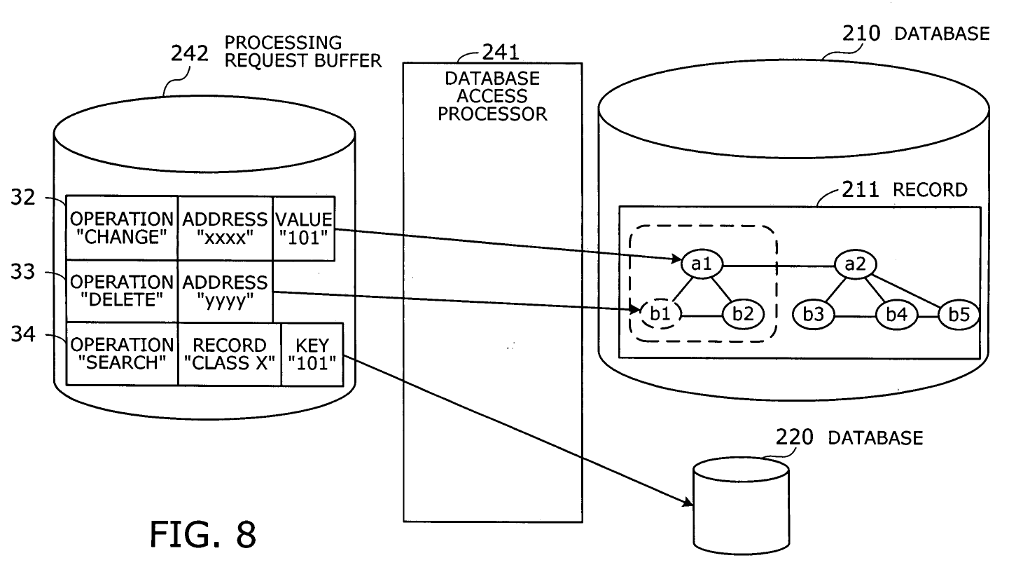

Upon receipt of such a message 30, the database server 200 executes processing requests sequentially as they appear in that message 30, beginning with the one immediately after the header information 31. FIG. 8 illustrates how the database server 200 handles processing requests. The database access processor 241 extracts processing requests 32 to 34 from the received message 30 and stores them into the processing request storage unit 242 while preserving their order in the message 30. In the example of FIG. 8, the topmost entry of the processing request buffer 242 is the first processing request 32 in the message 30, which should be executed in the first place. This processing request 32 (“change”) is followed by another processing request 33 (“delete”) and then by yet another processing request 34 (“search”).

The database access processor 241 executes the processing requests in the processing request buffer 242 in the order that they are stored. Specifically, the database access processor 241 changes the specified data element “a1” of the record 211 in the database 210 according to the first processing request 32. After that, it deletes another data element “b1” according to the next processing request 33. Lastly, the database access processor 241 retrieves a record of class X from another database 220 according to the last processing request 34.

### Process Flow

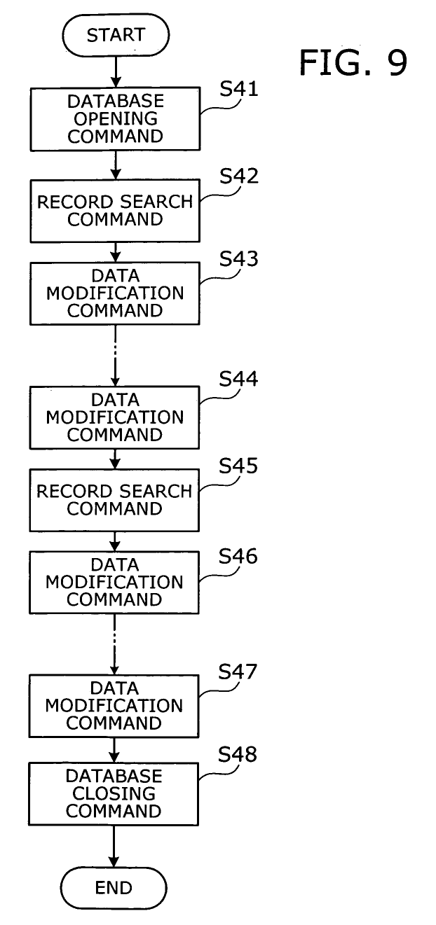

Referring to FIGS. 9 to 11, this section describes the process flow in the application 110, remote database access processor 121, and database access processor 241.

FIG. 9 shows a command sequence submitted by the application 110 in a single transaction. Specifically, the application 110 first sends a database opening command (step S41), which marks the beginning of a transaction. The application 110 then outputs a record search command (step S42), causing the application server 100 to obtain a subset of database records. Subsequently the application 110 issues data modification commands (e.g., change, delete, add) to manipulate data elements of the obtained subset of records (step S43).

After the last data modification command for the subset (step S44), the application 110 outputs a record search command to retrieve another subset of records for subsequent data processing (step S45). The application 110 manipulates the retrieved subset in the same way by issuing data modification commands to achieve its purpose (step S46). Upon outputting the last data modification command (step S47), the application 110 sends out a database closing command to terminate the current transaction.

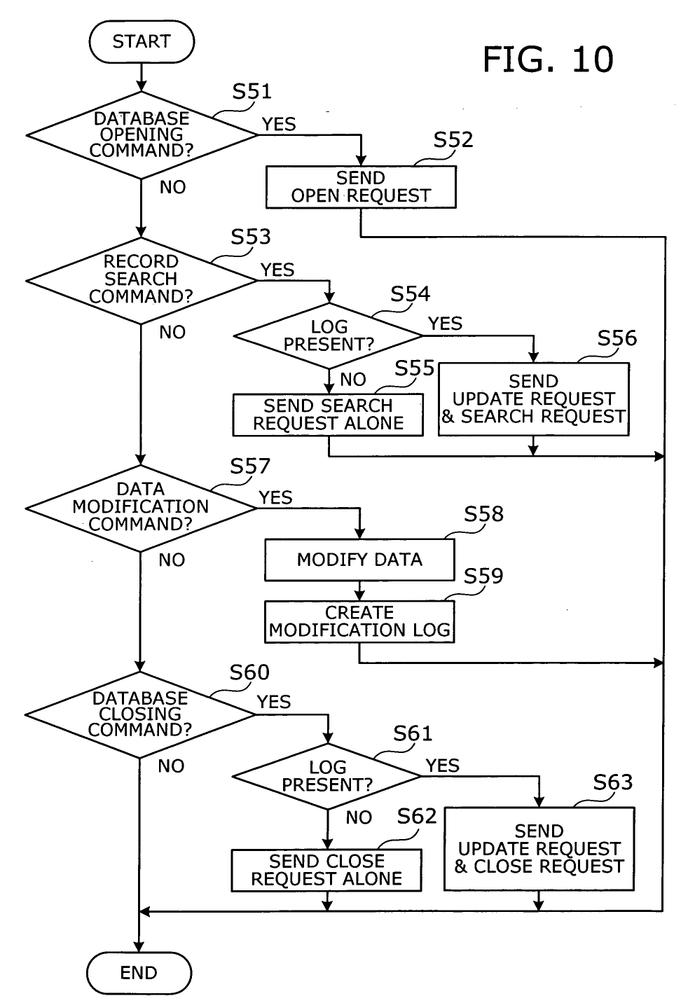

FIG. 10 is a flowchart showing how the remote database access processor 121 operates when a processing command comes in. Upon receipt of a processing command, the remote database access processor 121 determines whether it is a database opening command (step S51). If so, the remote database access processor 121 sends the database server 200 a message containing an open request (step S52).

If the received processing command is not a database opening command, then the remote database access processor 121 determines whether it is a record search command (step S53). If it is, then the remote database access processor 121 consults the modification log storage unit 122 to determine whether there is a modification log (step S54). If no such log is found, the remote database access processor 121 sends the database server 200 a message containing a search request alone (step S55). If a modification log is present, the remote database access processor 121 creates a message containing not only a search request, but also update requests produced from the modification log that is found. This message is transmitted to the database server 200 (step S56).

In the case where the received processing command is neither a database opening command nor a record search command, then the remote database access processor 121 determines whether it is a data modification command (step S57). If it is, then the remote database access processor 121 modifies the specified data element according to the command (step S58) while creating and registering a modification log in the modification log storage unit 122 (step S59).

If the received processing command is not a database opening command, record search command, or data modification command, then the remote database access processor 121 determines whether it is a database close command (step S60). If it is, the remote database access processor 121 determines whether a modification log is present in the modification log storage unit 122 (step S61). If no such log is found, the remote database access processor 121 sends the database server 200 a message containing a close request alone (step S62). If a modification log is found, then the remote database access processor 121 sends the database server 200 a message containing both an update request and a close request (step S63). In this way, the application server 100 creates and sends a message to the database server 200 according to a command from the application 110.

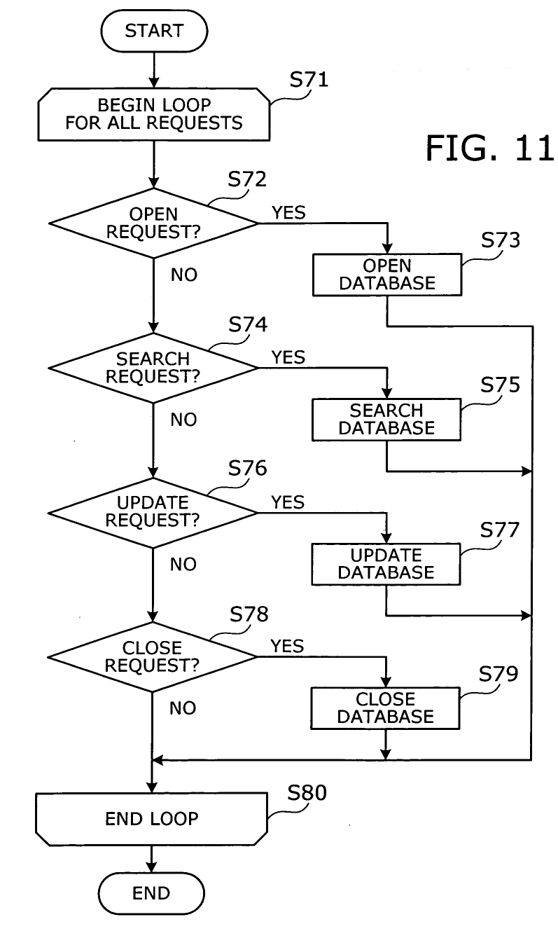

Referring next to FIG. 11, the following will describe what the database access processor 241 in the database server 200 performs when a message is received. FIG. 11 is a flowchart showing the operation of the database access processor 241. The database access processor 241 repeats the following steps S72 to S79 as many times as the number of processing requests in the received message, beginning from the one close to the header information field (step S71).

The database access processor 241 starts with determining whether the processing request of interest is an open request (step S72). If it is, the database access processor 241 opens the specified database (step S73). If not, then it is determined whether the processing request is a search request (step S74). If it is, then the database access processor 241 searches the specified database according to the search request (step S75).

In the case where the processing request is neither an open request nor a search request, the database access processor 241 determines whether it is an update request (step S76). If it is, the database access processor 241 updates the specified database record according to the given update request (step S77).

In the case where the processing request is not an open request, a search request, or an update request, the database access processor 241 determines whether it is a close request (step S78). If it is, the database access processor 241 closes the database (i.e., releases allocated memory after committing the database) (step S79).

The database access processor 241 exits from the above loop of message processing when all processing requests are served (step S80).

### Computer-Readable Storage Media

As can be seen from the preceding sections, the present embodiment sends data update requests to a database server by using a message that is primarily for carrying a search request or a close request. The shared use of messages contributes to reduction of message traffic between application servers and database servers, thus enabling the system to provide data processing services more efficiently.

The above-described processing mechanisms of the application server 100 and database server 200 are each implemented on a computer system, the instructions being encoded and provided in the form of computer programs. Those programs are executed on a computer platform to provide the intended functions of the present invention. For the purpose of storage and distribution, the programs are stored in a computer-readable storage medium. Suitable computer-readable storage media include magnetic storage media, optical discs, magneto-optical storage media, and semiconductor memory devices. Magnetic storage media include hard disk drives (HDD), flexible disks (FD), and magnetic tapes. Optical disc media include digital versatile discs (DVD), DVD-RAM, compact disc read-only memory (CD-ROM), CD-Recordable (CD-R), and CD-Rewritable (CD-RW). Magneto-optical storage media include magneto-optical discs (MO).

Portable storage media, such as DVD and CD-ROM, are suitable for the distribution of program products. Network-based distribution of software programs is also possible, in which case several master program files are made available on a server computer for downloading to other computers via a network.

A user computer stores necessary programs in its local storage unit, which have previously been installed from a portable storage media or downloaded from a server computer. The computer executes those programs read out of the local storage unit, thereby performing the programmed functions. As an alternative way of program execution, the computer may execute programs, reading out program codes directly from a portable storage medium. Another alternative method is that the user computer dynamically downloads programs from a server computer when they are demanded and executes them upon delivery.

### CONCLUSION

According to the present invention, modifications made to retrieved database records are logged in a modification log. When a new record retrieval request arises, data update requests are produced from the modification log and sent to remote databases in a single message, together with the record retrieval request. The shared use of messages contributes to reduction of traffic of messages addressed to database servers, thus enabling more efficient database processing.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable medium storing a computer program for manipulating a remote database through remote access, the computer program causing a computer to function as a system comprising:
a record fetching unit that produces a record retrieval request to the remote database in response to a given record retrieval command;
a record storage unit that stores records retrieved from the remote database as a result of the record retrieval request;
a data modification unit that modifies data elements of the records stored in the record storage unit according to given data modification commands;
a modification logging unit that creates a modification log by keeping track of the modifications made by the data modification unit;
a modification log storage unit that stores the modification log created by the modification logging unit; and
a message sending unit that produces update requests from the modification log when the record fetching unit has produced a new record retrieval request and then sends the remote database a message containing the new record retrieval request and the update requests to update the remote database with the modifications made by the data modification unit.

2. The computer-readable medium according to claim 1, wherein the message sending unit produces update requests from the modification log also when a processing request other than the new record retrieval request is issued and sends the remote database a message containing the processing request and the update requests to the remote database.

3. The computer-readable medium according to claim 1, wherein the message sending unit arranges the record retrieval request and update requests in the message such that the remote database will execute the update requests earlier than the record retrieval request.

4. The computer-readable medium according to claim 3, wherein:
the remote database is previously configured to execute requests in a received message according to the order of appearance in that message after header information thereof; and
the message sending unit produces the message by placing header information, the update requests, and the update record retrieval request in that order.

5. The computer-readable medium according to claim 3, wherein:
the modification log contains a plurality of modification log entries; and
the message sending unit produces the message by arranging the plurality of update requests such that the remote database will execute the update requests in the order that the corresponding modification log entries are recorded in the modification log.

6. A method for manipulating a remote database through remote access, the method comprising the steps of:
(a) sending a record retrieval request to the remote database in response to a given record retrieval command;
(b) storing records retrieved from the remote database as a result of the record retrieval request;
(c) modifying data elements of the stored records according to given data modification commands;
(d) creating a modification log by keeping track of the modifications made to the stored records;
(e) producing update requests from the modification log when a new record retrieval request is produced; and
(f) sending the remote database a message containing the new record retrieval request and the update requests to update the remote database with the modifications that have been made to the stored records.

7. An apparatus for manipulating a remote database through remote access, the apparatus comprising:
a record fetching unit that produces a record retrieval request to the remote database in response to a given record retrieval command;
a record storage unit that stores records retrieved from the remote database as a result of the record retrieval request;
a data modification unit that modifies data elements of the records stored in the record storage unit according to given data modification commands;
a modification logging unit that creates a modification log by keeping track of the modifications made by the data modification unit;
a modification log storage unit that stores the modification log created by the modification logging unit; and
a message sending unit that produces update requests from the modification log when the record fetching unit has produced a new record retrieval request and then sends the remote database a message containing the new record retrieval request and the update requests to update the remote database with the modifications made by the data modification unit.
